(19) United States
(12) Patent Application Publication
(10) Pub. No.: US 2023/0136550 A1
(43) Pub. Date: May 4, 2023

(54) METHOD AND APPARATUS FOR UPLINK RESOURCE ALLOCATION

(71) Applicant: Lenovo (Beijing) Ltd., Beijing (CN)

(72) Inventor: Haipeng Lei, Beijing (CN)

(73) Assignee: Lenovo (Beijing) Ltd., Beijing (CN)

(21) Appl. No.: 17/917,791

(22) PCT Filed: Apr. 10, 2020
(86) PCT No.: PCT/CN2020/084204

§ 371 Date: Oct. 7, 2022

(51) Int. Cl. H04W 72/23; H04W 72/1268; H04L 27/26

(52) U.S. Cl. CPC H04W 72/23; H04W 72/1268; H04L 27/2605

(57) ABSTRACT

Embodiments of the present disclosure relate to methods and apparatuses uplink resource allocation. According to some embodiments of the disclosure, a method may include: receiving a downlink control information (DCI) in a downlink bandwidth part (BWP), wherein the DCI may schedule an uplink transmission in an uplink BWP; and transmitting, based on the DCI, the uplink transmission on at least one resource block (RB) set of a first plurality of RB sets in response to a channel access procedure for each of the at least one RB set is successful. Each of the first plurality of RB sets may include a plurality of contiguous RBs in the uplink BWP, and a guard band may be configured between two adjacent RB sets of the first plurality of RB sets.

### TECHNICAL FIELD

Embodiments of the present disclosure generally relate to wireless communication technology, and more particularly to uplink resource allocation scheduled by downlink control information (DCI).

### BACKGROUND

A user equipment (UE) may monitor a downlink control channel in one or more search spaces. For example, a UE may monitor a physical downlink control channel (PDCCH) in one or more search spaces associated with a control resource set (CORESET). The PDCCH may carry DCI, which may schedule uplink channels, such as a physical uplink shared channel (PUSCH), or downlink channels, such as a physical downlink shared channel (PDSCH).

Base stations (BSs) and UEs may operate in both a licensed spectrum and an unlicensed spectrum. There is a need for handling uplink resource allocation scheduled by DCI on an unlicensed spectrum.

### SUMMARY

Some embodiments of the present disclosure provide a method. The method may include: receiving a downlink control information (DCI) in a downlink bandwidth part (BWP), wherein the DCI may schedule an uplink transmission in an uplink BWP; and transmitting, based on the DCI, the uplink transmission on at least one resource block (RB) set of a first plurality of RB sets in response to a channel access procedure for each of the at least one RB set is successful, wherein each of the first plurality of RB sets may include a plurality of contiguous RBs in the uplink BWP, and a guard band may be configured between two adjacent RB sets of the first plurality of RB sets.

Some embodiments of the present disclosure provide a method. The method may include: transmitting a downlink control information (DCI) in a downlink bandwidth part (BWP), wherein the DCI may schedule an uplink transmission in an uplink BWP; and receiving, based on the DCI, the uplink transmission on at least one resource block (RB) set of a first plurality of RB sets, wherein each of the first plurality of RB sets may include a plurality of contiguous RBs in the uplink BWP, and a guard band may be configured between two adjacent RB sets of the first plurality of RB sets.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, to cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example of interlace-based resource block configuration in accordance with some embodiments of the present disclosure;

FIG. 3 illustrates an example of carrier bandwidth configuration in accordance with some embodiments of the present disclosure;

FIG. 4 illustrates a flow chart of an exemplary procedure of handling communications in accordance with some embodiments of the present disclosure;

FIG. 5 illustrates a flow chart of an exemplary procedure of wireless communications in accordance with some embodiments of the present disclosure;

FIG. 6 illustrates a flow chart of an exemplary procedure of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

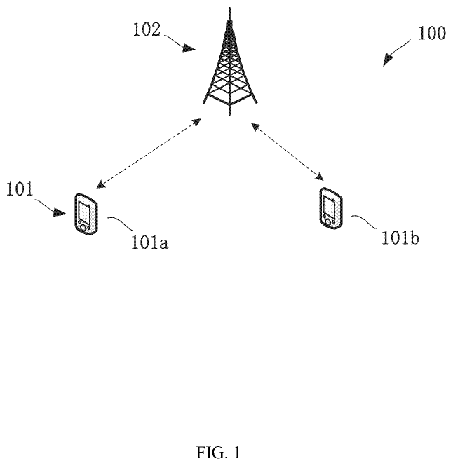

FIG. 1 illustrates a schematic diagram of a wireless communication system in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with BSs 102 via uplink (UL) communication signals.

The BS 102 may be distributed over a geographic region. In certain embodiments of the present disclosure, each of the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 102 may transmit data using an OFDM modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in other embodiments, the BS 102 and UE(s) 101 may communicate over unlicensed spectrums. The present disclosure is not intended to be limited to the implementation of any particular wireless communication system architecture or protocol.

Wireless transmission on an unlicensed spectrum should meet the requirements of the regulations subject to the management of the country/region where a wireless communication device (e.g., a UE) is located. The design of an uplink waveform for NR-U (NR system access on unlicensed spectrum) PUSCH (Physical Uplink Shared Channel)/PUCCH (physical uplink control channel) should meet these regulation requirements on an unlicensed spectrum. The requirements mainly include two aspects:
(1) occupied channel bandwidth (OCB): the bandwidth containing 99% of the power of the signal, shall be between 80% and 100% of the declared Nominal Channel Bandwidth; and
(2) maximum power spectrum density (PSD) with a resolution bandwidth of 1 MHz (e.g., 10 dBm/MHz).

The above two requirements dictate that a signal which occupies a small portion of the channel bandwidth cannot be transmitted at the maximum available power at the UE due to the PSD and OCB constraints.

To meet the regulation requirements, an interlace-based waveform is employed as an uplink waveform for an unlicensed spectrum. For example, in LTE and NR systems the interlace-based waveform may be applied to uplink (UL) transmission on the unlicensed spectrum.

In LTE, the bandwidth of a carrier is 20 MHz. The 20 MHz bandwidth may include 100 physical resource blocks (PRBs), which are partitioned into 10 interlaces. Each interlace may include 10 PRBs, and all the interlaces may be equally distributed within the whole bandwidth. In this way, each interlace spans more than 80% system bandwidth so that the regulation requirements of the OCB can be met. Moreover, 10 PRBs of one interlace are equally spaced in frequency so that two adjacent PRBs of one interlace are separated by a 1.8 MHz distance, and thus power boosting can be realized for each PRB of one interlace.

In NR systems, an interlace, as a frequency resource, may be defined as a set of common resource blocks (CRBs) which may be evenly spaced in frequency domain. For example, assuming that there are M interlaces (indexed as 0, 1, . . . , M−1, respectively), an interlace in (m ∈ {0,1, . . . , M−1} may consist of CRBs {m, M+m, 2M+m, 3M+m, . . . }. The correspondence between the interlaced resource block (IRB) n_{IRB,m}^{μ}∈{0,1, . . . } in bandwidth part (BWP) i. and interlace in and the common resource block n_{CRB}^{μ} is given by the equation:

n_{CRB}^{μ}=Mn_{IRB,m}^{μ}+N_{BWP,i}^{start,μ}+((m−N_{BWP,i}^{start,μ}) mod M),

wherein, N_{BWP,i}^{start,μ} denotes the common resource block where bandwidth part i starts relative to common resource block 0, and μ indicates a subcarrier spacing (SCS). For example, “μ=0” may indicate a SCS of 15 kHz, “μ=1” may indicate a SCS of 30 kHz, “μ=2” may indicate a SCS of 60 kHz, and “μ=3” may indicate a SCS of 120 kHz. When there is no risk of confusion, the index μ in the above equation and parameters may be eliminated.

In some embodiments of the present disclosure, the number of interlaces distributed within the bandwidth of a carrier may be based on only the subcarrier spacing regardless of the bandwidth of the carrier. The subcarrier spacing of NR systems may be 15×2ⁿ kHz, where n is an integer. The subcarrier spacing may be 15 kHz, 30 kHz, or 60 kHz for frequency range 1 (FR1), and different subcarrier spacing values can support different maximum bandwidths. In some examples, for a carrier with 15 kHz subcarrier spacing, there may be 10 interlaces on the carrier. In some examples, for a carrier with 30 kHz subcarrier spacing, there may be 5 interlaces on the carrier. In some examples, for a carrier with 60 kHz subcarrier spacing, there may be 2 or 3 interlaces on the carrier. It should be understood that the number of interlaces (e.g., 10 interlaces for a carrier with 15 kHz subcarrier spacing, or 5 interlaces for a carrier with 30 kHz subcarrier spacing) is only for illustrative purposes, and should not be construed as limits to the embodiments of the present disclosure.

Table 1 below shows some examples of NR bandwidth configurations for different subcarrier spacing. According to table 1, a maximum number of RBs (represented as N_{RB} in table 1) may be determined based on the subcarrier spacing and corresponding bandwidth. For example, if the bandwidth is 20 MHz and the subcarrier spacing (SCS) is 15 kHz, the maximum number of RBs may be 106; and if the bandwidth is 20 MHz and the SCS is 30 kHz, the maximum number of RBs may be 51. It should be understood that table 1 is only for illustrative purposes, and should not be construed as limiting the embodiments of the present disclosure.

TABLE 1

| subcarrier | 5 | 10 | 15 | 20 | 25 | 30 | 40 | 50 | 60 | 80 | 90 | 100 |
|---|---|---|---|---|---|---|---|---|---|---|---|---|
| spacing | MHz | MHz | MHz | MHz | MHz | MHz | MHz | MHz | MHz | MHz | MHz | MHz |
| (SCS) (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

In some embodiments of the present disclosure, the number of RBs of each interlace on a carrier may be dependent on the bandwidth of the carrier. For example, referring to table 1, if the carrier bandwidth is 20 MHz and the subcarrier spacing is 15 kHz, the maximum number of RBs included in the bandwidth may be 106. As mentioned above, for a carrier with 15 kHz subcarrier spacing, there may be 10 interlaces on the carrier. Each of the 10 interlaces includes 10 or 11 RBs (106/10=10.6). If the carrier bandwidth is 20 MHz and the subcarrier spacing is 30 kHz, the maximum number of RBs included in the bandwidth may be 51. In this case, as mentioned above, for a carrier with 30kHz subcarrier spacing, there may be 5 interlaces on the carrier. Each of the 5 interlaces includes 10 or 11 RBs (51/5=10.2).

In some embodiments of the present disclosure, for carrier bandwidth larger than 20 MHz, the same spacing between consecutive RBs in an interlace is maintained for all interlaces regardless of the carrier bandwidth. In other words, the number of RBs per interlace may be dependent on the carrier bandwidth. Keeping the same interlace spacing with an increasing bandwidth is a straightforward and simple way to scale the interlace design from 20 MHz to a wider bandwidth.

For example, if the carrier bandwidth is 80 MHz and the subcarrier spacing is 30 kHz, according to table 1, the maximum number of RBs included in the bandwidth may be 217. Moreover, since the subcarrier spacing is 30 kHz, there are 5 interlaces on the carrier. In this scenario, each of the 5 interlaces may include 43 or 44 RBs (217/5=43.4).

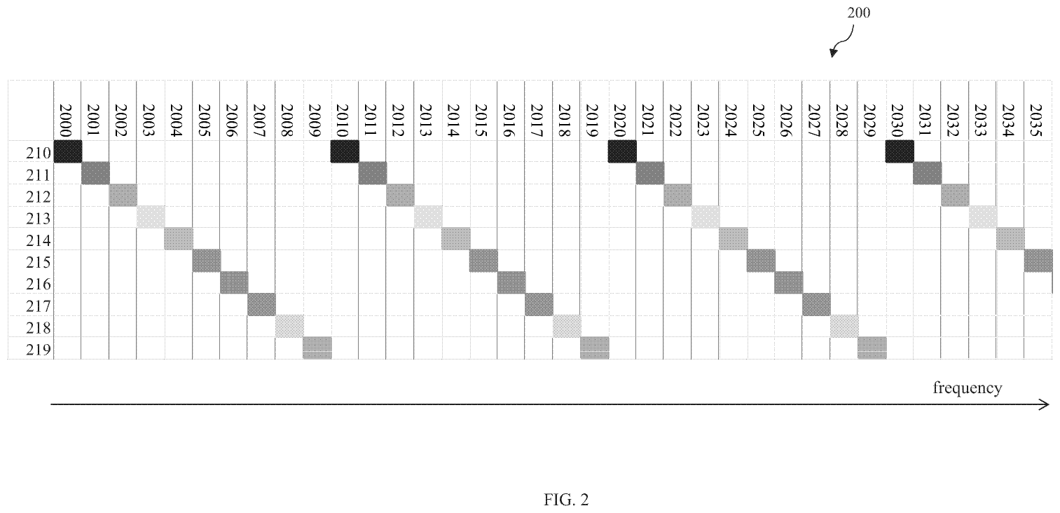

FIG. 2 illustrates an example of interlace-based resource block configuration 200 for 15 kHz subcarrier spacing according to some embodiments of the present disclosure. It should be understood that configuration 200 is only for illustrative purposes, and should not be construed as limits to the embodiments of the present disclosure.

As shown in FIG. 2, a carrier bandwidth may be partitioned into resource blocks (RBs). As an illustrative purpose, FIG. 2 only shows a part of the RBs (e.g., RBs that are represented with reference numerals 2000 to 2035 in FIG. 2) included in the carrier bandwidth. Persons skilled in the art can readily know the number of RBs included in a certain carrier bandwidth by referring to, for example, table 1 as shown above. For example, assuming that the carrier bandwidth is 15 MHz, the carrier bandwidth may include 79 RBs; and assuming that the carrier bandwidth is 20 MHz, the carrier bandwidth may include 106 RBs.

As mentioned above, the number of interlaces distributed within the bandwidth of a carrier may be based on only the subcarrier spacing regardless of the bandwidth of the carrier. In the example of FIG. 2, the RBs of the carrier bandwidth are partitioned into 10 interlaces (corresponding to the 15 kHz subcarrier spacing), which are respectively represented with reference numerals 210, 211, 212, 213, 214, 215, 216, 217, 218, and 219 in FIG. 2.

Each interlace of the 10 interlaces may include evenly-spaced RBs in frequency domain. The number of RBs included in each of the 10 interlaces may depend on the carrier bandwidth. As shown in FIG. 2, the interlace represented with reference numeral 210 may include RB 2000, RB 2010, RB 2020, RB 2030, and so on; the interlace represented with reference numeral 211 may include RB 2001, RB 2011, RB 2021, RB 2031, and so on; and the interlace represented with reference numeral 219 may include RB 2009, RB 2019, RB 2029, and so on. RB 2000 to RB 2035 may be indexed from “0” to “35” along the frequency axis, and interlaces 210 to 219 may be indexed from “0” to “9.”

In NR-U, a very wide bandwidth may be supported, for example, up to 100 MHz bandwidth for FR1. NR-U operating bandwidth may be an integer multiple of 20 MHz. In order to achieve fair coexistence between NR systems (e.g., NR-U systems) and other wireless systems (e.g., Wi-Fi), a channel access procedure on the unlicensed spectrum, also known as a listen-before-talk (LBT) test, may be performed in units of 20 MHz, before communicating on the unlicensed spectrum. For a carrier bandwidth larger than 20 MHz, e.g., 40 MHz, 60 MHz, 80 MHz, or 100 MHz, the carrier bandwidth may be partitioned into a plurality of subbands (also referred to as “LBT subbands”), each of which has a bandwidth of 20 MHz and may be indexed. An independent LBT test may be performed on each of these subbands (i.e., per subband). In some examples, one or more subbands may be scheduled for UL transmission, a UE may not perform the UL transmission (e.g., transmitting PUSCH) if the LBT test for any of the scheduled subband(s) fails. The UE may continue to perform another LBT test until a successful LBT test result. Only when the LBT test(s) on all of the scheduled subband(s) is successful can a UE start the UL transmission, and occupy the channel up to a maximum channel occupancy time (MCOT).

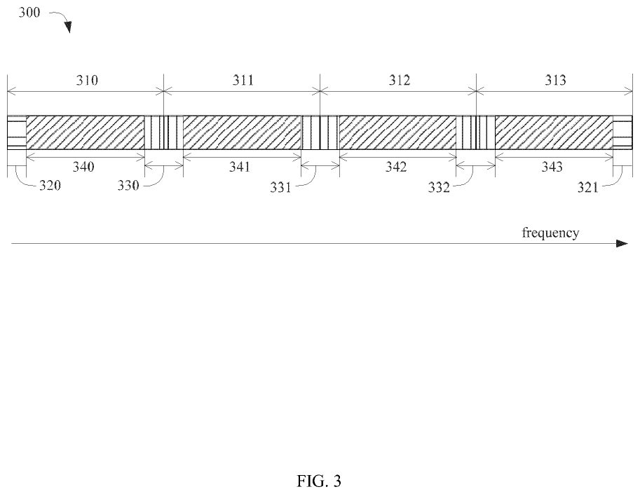

FIG. 3 illustrates an exemplary bandwidth configuration for a carrier 300 in accordance with some embodiments of the present disclosure. The configuration may be used by wireless devices, such as the UEs 101 and BS 102 described with reference to FIG. 1.

In FIG. 3, the bandwidth of the carrier 300 may be 80 MHz, and may be partitioned into 4 subbands (e.g., subband 310, subband 311, subband 312, and subband 313). Each of the 4 subbands may have a bandwidth of 20 MHz. Subband 310, subband 311, subband 312, and subband 313 within the carrier bandwidth may be indexed from “0” to “3” along the frequency axis.

At the edges of the carrier bandwidth, inter-carrier guard bands 320 and 321 may be specified to avoid interferences between different operation carriers. Under certain circumstances, intra-carrier guard bands (e.g., intra-carrier guard bands 330-332 in FIG. 3) may also be specified between two adjacent subbands. The intra-carrier guard bands 330-332 may be arranged according to various methods, for example, by scheduling empty resource blocks where a guard is needed.

The resource blocks (RBs) in a subband excluding the inter-carrier guard band and intra-carrier guard bands (if any) in the subband may be referred to as available RBs in the subband, and may form an RB set. For example, as shown in FIG. 3, subband 310, subband 311, subband 312, and subband 313 may respectively include RB set 340, RB set 341, RB set 342, RB set 343, which may be indexed from “0” to “3” along the frequency axis and may be respectively referred to as RB set 0, RB set 1 and so on.

In some embodiments of the present disclosure, the guard bands and RB-sets are configured by radio resource control (RRC) signaling in the unit of CRB. For example, when a UE is configured with an RRC parameter for an uplink carrier (e.g., “intraCellGuardBandUL-r16”), an RRC parameter for a downlink carrier (e.g., “intraCellGuardBandDL-r16”), or both, the UE may be provided with intra-cell guard bands on a carrier. As mentioned above, the intra-cell guard bands may separate RB sets within the carrier. Assuming that the number of RB sets in the carrier is N_{RB-set}, the number of intra-cell guard bands may be N_{RB-set}−1. The RB sets in the carrier may be indexed as “0,” “1,” . . . “N_{RB-set}−1.” For example, referring to FIG. 3, N_{RB-set} may be 4 (e.g., RB sets 340-343), and the number of intra-cell guard bands may be 3 (e.g., intra-carrier guard bands 330-332).

Each of the intra-cell guard bands may be defined by a start CRB (GBₛ^{start,μ}) and an end CRB (GBₛ^{end,μ}), and each of the RB sets may be defined by a start CRB (RBₛ^{start,μ}) and an end CRB (RBₛ^{end,μ}), where μ indicates the corresponding SCS of the carrier.

The UE may determine the start CRB of RB set 0 (e.g., RB set 340 in FIG. 3) within the carrier bandwidth according to RB₀^{start,μ}=N_{grid}^{start,μ}, and may determine the end CRB of the RB set N_{RB-set}−1 (e.g., RB set 343 in FIG. 3) within the carrier bandwidth according to RB_{N}_{_{RB−set}}_{'11}^{end,μ}=N_{grid}^{start,μ}+N_{grid}^{size,μ}, wherein, N_{grid}^{start,μ} denotes the starting CRB on the carrier (i.e., the first usable CRB on the carrier) and N_{grid}^{size,μ} denotes the carrier bandwidth in number of RBs on the carrier. The UE may determine the remaining start CRBs and end CRBs of the RB sets according to RBₛ^{end,μ}=GBₛ^{start,μ}−1 and RBₛ₊₁^{start,μ}=GBₛ^{end,μ}+1, wherein, s ∈{0, 1, . . . , N_{RB-set}−2}.

In some embodiments of the present disclosure, the UE may not be configured with the RRC parameter for the uplink carrier (e.g., “intraCellGuardBandUL-r16”), and the UE may determine the intra-cell guard bands and the RB sets according to a default intra-cell guard band pattern corresponding to and the carrier size N_{grid}^{size,μ}, as defined in 3GPP specification TS 38.101.

In some embodiments of the present disclosure, the UE may not be configured with the RRC parameter for the downlink carrier (e.g., “intraCellGuardBandDL-r16”), the UE may determine the intra-cell guard bands and the RB sets according to a default intra-cell guard band pattern corresponding to μ and the carrier bandwidth size N_{grid}^{size,μ}, as defined in 3GPP specification TS 38.101.

In some embodiments of the present disclosure, the configuration of the RRC parameter for an uplink carrier (e.g., “intraCellGuardBandUL-r16”) and the RRC parameter for a downlink carrier (e.g., “intraCellGuardBandDL-r16”) may indicate to a UE that no intra-cell guard bands are configured.

A UE may be configured with one or more carrier bandwidth part (BWP) for uplink communication or downlink communication. However, for a UE, there is at most one active downlink BWP and at most one active uplink BWP at a given time. A UE may communicate on an initial BWP during the initial access until the UE is explicitly configured with BWPs during or after RRC connection establishment. A BWP may include a set of contiguous physical resource blocks (PRBs). These PRBs may be selected from a subset of contiguous CRBs for a given numerology (μ) on a given carrier. For a carrier configured with intra-carrier guard bands, a UE may not expect to receive a BWP configuration (which may be signaled by RRC parameters such as “BWP-Downlink” and “BWP-Uplink”) partially overlapping with an RB set. RB sets within a BWP may form a set (S_{RB-sets}) of cardinality (N_{RB-set}^{BWP}).

The 3GPP protocol specifies several types of uplink resource allocations (e.g., uplink resource allocation type 0, uplink resource allocation type 1, and uplink resource allocation type 2) to indicate the method for uplink resource allocation in frequency domain. The specific definitions of these resource allocation types are defined in 3GPP specification TS 38.214.

In the uplink resource allocation type 2, a UE may be provided with frequency resource allocation information (e.g., in a DCI) indicating a set of interlaces and optionally a set of RB sets. The UE may determine the resource allocation in frequency domain (for example, PRBs for PUSCH transmission) as an intersection of the RBs of the indicated interlace(s), the indicated set of RB set(s), and the intra-cell guard band(s) between the indicated RB sets, if any.

In some embodiments of the present disclosure, when a higher layer (e.g., RRC) parameter about the usage of interlace (e.g., “useInterlacePUSCH-Dedicated-r16”) is configured, in a DCI (e.g., DCI format 0_1), (X+Y) bits may provide the above-mentioned frequency domain resource allocation, wherein the X most significant bits (MSBs) may provide the above-mentioned interlace allocation, and the Y least significant bits (LSBs) may provide the above-mentioned RB set allocation. These Y bits may also be referred to as RB set indication.

In some examples, the value of X may be equal to 6 when the subcarrier spacing for the active uplink BWP is 15 kHz. In some examples, the value of X may be equal to 5 when the subcarrier spacing for the active uplink BWP is 30 kHz. It should be understood that the above-mentioned values of X are only for illustrative purposes, and should not be construed as limiting the embodiments of the present disclosure.

In some examples, the value of Y may be determined according to

$$Y = ⌈ log 2 \frac{{N}_{RB - set}^{BWP} ( {N}_{RB - set}^{BWP} + 1 )}{2} ⌉ ,$$

where “┌ ┐” is the ceiling function, and N_{RB-set}^{BWP} is the number of RB sets contained in the active uplink BWP.

In some embodiments of the present disclosure, the frequency domain resource allocation information included in a DCI format 0_1 may indicate to a UE a set of up to M interlaces and a set of up to N_{RB-set}^{BWP} contiguous RB sets, wherein M denotes the total number of interlaces dependent on subcarrier spacing (SCS) as mentioned above. For example, M may be equal to 10 for a carrier with 15 kHz SCS, and M may be equal to 5 for a carrier with 30 kHz SCS.

The number of RB sets may be dependent on SCS and a maximum integer multiple of 20 MHz. In some embodiments of the present disclosure, the number of RB sets in a certain bandwidth may be the greatest integer less than or equal to the result of dividing the bandwidth by the bandwidth of a subband (e.g., 20 MHz).

For example, referring to the above-mentioned table 1, different SCS values can support different maximum bandwidths. In table 1, the 15 kHz SCS may support a maximum available bandwidth of 50 MHz. Since the 50 MHz bandwidth is not an integer multiple of 20 MHz bandwidths, the 50 MHz bandwidth may be not supported for unlicensed spectrum. So the maximum bandwidth for 15 kHz SCS may be 40 MHz bandwidth, and there are 2 RB sets for a carrier with 15 kHz SCS and 40 MHz bandwidth. The 30 kHz SCS and 60 kHz SCS may support a maximum available bandwidth of 100 MHz. Since the 100 MHz bandwidth contains a maximum of five 20 MHz bandwidths, there are a maximum of 5 RB sets for the 30 kHz SCS and 60 kHz SCS.

According to the above-mentioned equation for determining the value of Y, assuming that the number of RB sets in an uplink BWP is N, the number of required bits for RB set indication is

$$⌈ {log}_{2} ( \frac{N ( N + 1 )}{2} ) ⌉ .$$

Since according to the table 1, there are maximum of 2 RB (e.g., N=2) sets for the 15 kHz SCS, and there are a maximum of 5 RB (e.g., N=5) sets for the 30 kHz SCS and 60 kHz SCS; 2 bits (e.g., Y=2) are required for RB set indication in case of 15 kHz SCS, and 4 bits (e.g., Y=4) are required for RB set indication in case of 30 kHz SCS or 60 kHz SCS.

To decode the PDCCH (e.g., the DCI), a UE may need to figure out several parameters such as control channel element (CCE) index, aggregation level, and scrambling code. As the UE is not explicitly informed of these parameters, it may need to perform a blind decoding in a predefined region (which is also known as a search space). There are two types of search spaces, one is common search space (CSS) and another is UE-specific search space (USS). The CSS may carry common control information and may be monitored by all UEs in a cell or a group of UEs in a cell. The USS may carry control information specific to a particular UE and may be monitored by a particular UE in a cell. The 3GPP specification specifies several types of CSS, each of which may be applied to different applications. For example, type 1 PDCCH CSS may be employed during a random access (RA) procedure, and may transmit the DCI with a cyclic redundancy check (CRC) scrambled by, for example, RA radio network temporary identifier (RNTI), temporary cell RNTI (TC-RNTI), or cell RNTI (C-RNTI) on a primary cell.

DCI format 0-1 (also known as non-fallback DCI) and DCI format 0_0 (also known as fallback DCI) may be used for scheduling uplink transmission (e.g., PUSCH). As mentioned above, the DCI format 0_1 may include X+Y bits for uplink frequency domain resource allocation (e.g., including interlace indication and RB set indication). However, this may not be the case for the fallback DCI.

In some embodiments of the present disclosure, when uplink transmission is scheduled by DCI format 0_0 with CRC scrambled by TC-RNTI in a type 1 PDCCH CSS, the active uplink BWP is always the initial uplink BWP. When uplink transmission is scheduled by DCI format 0_0 with CRC scrambled by C-RNTI, configured scheduling RNTI (CS-RNTI), or modulation coding scheme cell RNTI (MCS-C-RNTI), the uplink transmission may be scheduled in an active UL BWP different from the initial UL BWP. Since DCI format 0_0 does not support BWP switching, the uplink transmission scheduled by DCI format 0_0 in the CSS may not be always restricted in the initial uplink BWP. Therefore, DCI format 0_0 transmitted in the CSS may not indicate the specific RB set(s) for uplink transmission (that is, not including the Y bits for RB set indication).

In some embodiments of the present disclosure, the DCI format 0_0 transmitted in the USS may or may not include the above-mentioned Y bits for RB set indication.

From the perspective of reliability, the fallback DCI should be sufficiently reliable so as to avoid unnecessary bits therein. In some cases, in order to guarantee the reliability of the fallback DCI, sacrifice of scheduling flexibility or performance may be accepted. Furthermore, since as mentioned above, the fallback DCI transmitted in CSS may not include the Y bits for RB set indication, when the fallback DCI transmitted in USS includes such bits for RB set indication, fallback DCI transmitted in a CSS and fallback DCI transmitted in a USS may have different payload sizes. In this scenario, the maximum allowed different payload sizes of DCI (e.g., with CRC scrambled by C-RNTI), which may be three, may be exceeded because the UE may need to monitor four DCI with different payload sizes, for example, DCI format 0_0 in CSS, DCI format 0_0 in USS, DCI format 0_1, and DCI format 1_1. This may inevitably increase UE's effort in blind detection. Therefore, it would be advantageous that the fallback DCI transmitted in the CSS and USS does not include the RB set indication.

However, in the case that the fallback DCI, regardless of transmission in a CSS or USS, does not include any RB set indication, it may be problematic when the active uplink BWP includes more than one RB set since it may be unclear which of the more than one RB set is used for the uplink transmission scheduled by the fallback DCI. Therefore, solutions need to be provided for determining the RB set(s) scheduled by the fallback DCI.

In some embodiments of the present disclosure, a UE may assume that the indicated interlace(s) are transmitted on all of the RB set(s) in the active uplink BWP. Before RRC connection establishment, the initial uplink BWP may include a single RB set. In this case, the above-mentioned problem may be properly solved.

However, when the intra-cell guard bands are reconfigured for a UE in a CONNECTED mode, the UE behavior for PUSCH allocation during the ambiguity period could become unclear. Moreover, in some cases, all RB sets in the active uplink BWP being used for uplink transmission (e.g., PUSCH) may lead to problems such as: (1) too many resources may be scheduled for uplink transmission with a small packet size; and (2) high risk on the LBT test since a UE cannot transmit the PUSCH if the LBT test for one subband or one RB set fails.

Therefore, improved solutions need to be provided for determining the RB set(s) scheduled by a fallback DCI transmitted in either a CSS or USS. More details on the embodiments of the present disclosure will be illustrated in the following text in combination with the appended drawings.

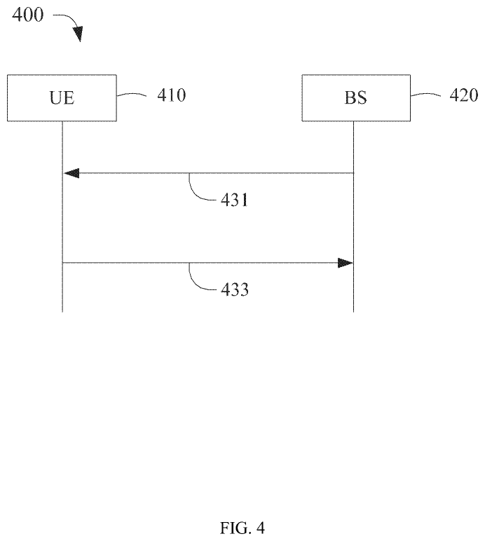

FIG. 4 illustrates a flow chart of an exemplary procedure 400 of handling communications according to some embodiments of the present disclosure. Details described in all of the foregoing embodiments of the present disclosure are applicable for the embodiments shown in FIG. 4.

The exemplary procedure 400 shows a procedure of a UE (e.g., UE 410) communicating with a BS (e.g., BS 420). In some examples, UE 410 may function as UE 101a or UE 101b in FIG. 1, and BS 420 may function as BS 102 in FIG. 1.

Referring to FIG. 4, in operation 431, UE 410 may receive a DCI in a downlink BWP from BS 420. The DCI may schedule an uplink transmission (e.g., PUSCH) in an uplink BWP. The uplink BWP may be configured in a manner similar to the one shown in FIG. 3.

For example, the uplink BWP may include a plurality of subbands, each of which may include an RB set. Thus, the uplink BWP may include a plurality of RB sets (for clearness, hereafter referred to as “the first plurality of RB sets”). The number of the first plurality of RB sets may be the greatest integer less than or equal to the result of dividing the bandwidth of the uplink BWP by the bandwidth of a subband (e.g., 20 MHz). Each of the RB sets may include a plurality of contiguous RBs in the uplink BWP. A guard band (e.g., intra-carrier guard band) may be configured between two adjacent RB sets. In some examples, the uplink BWP may include only one subband and one corresponding RB set.

In some embodiments of the present disclosure, UE 410 may determine, based on the DCI, at least one RB set of the first plurality of RB sets in the uplink BWP for transmitting the uplink transmission. In some embodiments of the present disclosure, the DCI may be DCI format 0_1. DCI format 0_1 include (X+Y) bits for uplink frequency domain resource allocation. UE 410 may determine the at least one RB set based on the Y bits for RB set indication.

In some embodiments of the present disclosure, the DCI may be DCI format 0_0. The DCI may include a frequency hopping flag having at least one bit. The frequency hopping flag may be reused to indicate as RB set indication for uplink transmission. For example, the frequency hopping flag may indicate the at least one RB set for the uplink transmission.

In some embodiments of the present disclosure, the frequency hopping flag may indicate one of two predefined RB sets of the first plurality of RB sets in the uplink BWP. In some embodiments of the present disclosure, the frequency hopping flag may indicate the number of RB sets from two predefined RB sets of the first plurality of RB sets. In some embodiments of the present disclosure, the two predefined RB sets may be two RB sets of the first plurality of RB sets having the two lowest indices or the two lowest central frequency points. In some other embodiments of the present disclosure, the two predefined RB sets may be determined from the first plurality of RB sets based on other criteria.

In some examples, according to the above-mentioned table 1, for an active uplink BWP with 15 kHz SCS, there are a maximum of two RB sets in the active uplink BWP in FR1 for 15 kHz SCS. The two RB sets may be indexed as “0” and “1,” and thus may be referred to RB set 0 and RB set 1, respectively.

In some cases, the frequency hopping flag may indicate which of the two RB sets is scheduled for uplink transmission. For example, the frequency hopping flag may include one bit. The value of the frequency hopping flag being “0” may indicate that RB set 0 is scheduled for uplink transmission, and the value of the frequency hopping flag being “1” may indicate that RB set 1 is scheduled for uplink transmission; or vice versa. In this example, only a single RB set can be scheduled for the uplink transmission since the frequency hopping flag only includes one bit. However, as mentioned above, in order to guarantee the reliability of the fallback DCI, sacrifice of scheduling flexibility or performance may be accepted.

In some cases, the frequency hopping flag may indicate the number of RB sets (e.g., 1 or 2) from the two RB sets for uplink transmission. For example, the frequency hopping flag may include one bit. The value of the frequency hopping flag being “0” may indicate that only one RB set of the two RB sets is scheduled for uplink transmission, and the value of the frequency hopping flag being “1” may indicate that both of the two RB sets are scheduled for uplink transmission; or vice versa. When the frequency hopping flag indicates that only one RB set is scheduled for uplink transmission, the UE may determine that a predefined default RB set is scheduled for uplink transmission. In these cases, RB set 0 (or RB set 1) may be predefined as the default RB set.

In some examples, according to the above-mentioned table 1, for an active uplink BWP with 30 kHz or 60 kHz SCS, there are a maximum of five RB sets in the active uplink BWP in FR1 for 30 kHz or 60 kHz SCS. The five RB sets may be indexed as “0” to “4,” and thus may be referred to RB set 0 to RB set 4, respectively.

In some embodiments of the present disclosure, the two predefined RB sets may be two RB sets having the lowest indices or the lowest central frequency points within the five RB sets. For example, the two predefined RB sets may be RB set 0 or RB set 1. In some other examples, the two predefined RB sets may be selected from the five RB sets based on other criteria.

In some cases, the frequency hopping flag may indicate which of the two predefined RB sets (e.g., RB set 0 or RB set 1) is scheduled for uplink transmission. For example, the frequency hopping flag may include one bit. The value of the frequency hopping flag being “0” may indicate that RB set 0 is scheduled for uplink transmission, and the value of the frequency hopping flag being “1” may indicate that RB set 1 is scheduled for uplink transmission; or vice versa. In this example, only a single RB set can be scheduled for the uplink transmission since the frequency hopping flag only includes one bit. However, as mentioned above, in order to guarantee the reliability of the fallback DCI, sacrifice of scheduling flexibility or performance may be accepted.

In some cases, the frequency hopping flag may indicate the number of RB sets (e.g., 1 or 2) from the two predefined RB sets for uplink transmission. For example, the frequency hopping flag may include one bit. The value of the frequency hopping flag being “0” may indicate that only one RB set of the two predefined RB sets is scheduled for uplink transmission, and the value of the frequency hopping flag being “1” may indicate that both of the two predefined RB sets are scheduled for uplink transmission; or vice versa. When the frequency hopping flag indicates that only one RB set is scheduled for uplink transmission, the UE may determine that a default RB set is scheduled for uplink transmission. In these cases, one of the two predefined RB sets (e.g., RB set 0 or RB set 1) may be predefined as the default RB set.

In some embodiments of the present disclosure, the frequency hopping flag may indicate that the at least one RB set includes RB sets of the first plurality of RB sets having odd RB set indices or even RB set indices.

For example, for an active uplink BWP with 15 kHz SCS, the frequency hopping flag may indicate an RB set (e.g., RB set 1) of the two RB sets having an odd RB set index or an RB set (e.g., RB set 0) of the two RB sets having an even RB set index.

For example, for an active uplink BWP with 30 kHz or 60 kHz SCS, the frequency hopping flag may indicate RB sets having odd RB set indices or RB sets of the five RB sets having even RB set indices within the five RB sets. For example, the frequency hopping flag may include one bit. The value of the frequency hopping flag being “0” may indicate that RB sets of the five RB sets having even RB set indices are scheduled for uplink transmission (e.g., RB set 0, RB set 2 and RB set 4 are scheduled), and the value of the frequency hopping flag being “1” may indicate that RB sets of the five RB sets having odd RB set indices are scheduled for uplink transmission (e.g., RB set 1 and RB set 3 are scheduled); or vice versa.

In some embodiments of the present disclosure, UE 410 may receive the DCI in an RB set in the downlink BWP. The RB set in the downlink BWP may have an RB set index (e.g., I), and a central frequency point (e.g., F).

In some embodiments of the present disclosure, one of the two predefined RB sets may have an RB set index equal to the RB set index I, and the other of the two predefined RB sets may have an RB set index equal to I−1 or I+1.

After receiving the DCI in RB set I in the active downlink BWP, UE 410 may determine that one predefined RB set is RB set I in the active uplink BWP, and the other predefined RB set is RB set I+1 or RB set I−1 in the active uplink BWP. The UE may further determine which of the two predefined RB sets in the uplink BWP is used for uplink transmission based on DCI (e.g., the frequency hopping flag in the DCI). As mentioned above, in some examples, the frequency hopping flag may indicate one (e.g., RB set I, RB set I+1, or RB set I−1) of two predefined RB sets in the uplink BWP for uplink transmission. In some examples, the frequency hopping flag may indicate the number of RB sets (e.g., 1 or 2) from the two predefined RB sets in the uplink BWP for uplink transmission.

In some embodiments of the present disclosure, one of the two predefined RB sets may have a central frequency point equal to the central frequency point F. Assuming that this predefined RB set has an RB set index PI, the other of the two predefined RB sets may have an RB set index equal to PI−1 or PI+1.

After receiving the DCI in an RB set with the central frequency point F in the active downlink BWP, UE 410 may determine that one predefined RB set with the same central frequency point F is RB set PI in the active uplink BWP, and the other predefined RB set is RB set PI+1 or RB set PI−1 in the active uplink BWP. The UE may further determine which of the two predefined RB sets in the uplink BWP is used for uplink transmission based on DCI (e.g., the frequency hopping flag in the DCI). As mentioned above, in some examples, the frequency hopping flag may indicate one (e.g., RB set PI, RB set PI+1, or RB set PI−1) of two predefined RB sets in the uplink BWP for uplink transmission. In some examples, the frequency hopping flag may indicate the number of RB sets (e.g., 1 or 2) from the two predefined RB sets in the uplink BWP for uplink transmission.

In some embodiments of the present disclosure, the frequency hopping flag in the DCI may not be reused. The at least one RB set in the uplink BWP for uplink transmission may be implicitly determined or predefined.

In some embodiments of the present disclosure, the at least one RB set may include an RB set having an RB set index I, i.e., the index of the RB set in the downlink BWP for the DCI. For example, after receiving the DCI in RB set I in the active downlink BWP, UE 410 may determine that RB set I in the active uplink BWP is scheduled for the uplink transmission.

In some embodiments of the present disclosure, the at least one RB set may include an RB set having a central frequency point F, i.e., the central frequency point of the RB set in the downlink BWP for the DCI. For example, after receiving the DCI in an RB set with the central frequency point F in the active downlink BWP, UE 410 may determine that RB set PI with the same central frequency point F in the active uplink BWP is scheduled for the uplink transmission.

In some embodiments of the present disclosure, the at least one RB set may include an RB set of the first plurality of RB sets in the uplink BWP having the lowest RB set index (e.g., RB set 0) or lowest central frequency point (e.g., RB set 340 in FIG. 3). In some embodiments of the present disclosure, the at least one RB set may include an RB set of the first plurality of RB sets in the uplink BWP having the highest RB set index (e.g., RB set 4 for an uplink BWP with 30 kHz or 60 kHz SCS) or highest central frequency point (e.g., RB set 343 in FIG. 3).

In some embodiments of the present disclosure, a search space (CSS or USS) of the DCI may include a plurality of RB sets (for clearness, hereafter referred to as “the second plurality of RB sets”). One of the second plurality of RB sets may be used as a reference RB set for determine the at least one RB set in the uplink BWP. In some examples, assuming that an RB set of the second plurality of RB sets with the lowest central frequency point has an RB set index Z, the at least one RB set for transmitting the uplink transmission may include an RB set of the first plurality of RB sets in the uplink BWP having the RB set index Z. In some examples, the at least one RB set for transmitting the uplink transmission includes an RB set of the first plurality of RB sets in the uplink BWP having a central frequency point equal to the lowest central frequency point of the second plurality of RB sets.

In some of the above embodiments, a UE may implicitly determine the RB set for uplink transmission based on the RB set in which the DCI is transmitted. In these embodiments, a BS may guarantee that the UE can transmit the uplink transmission on the determined RB set for uplink transmission. For example, when the active downlink BWP and the active uplink BWP have different numbers of RB sets, a BS may guarantee that the index of the RB set in the active downlink BWP for transmitting the DCI is not larger than the maximum index of the RB set in the active uplink BWP. In other words, a UE may not be expected to detect a DCI in an RB set in the active downlink BWP which has an RB index larger than the maximum index of the RB set in the active uplink BWP. In this case, when a UE determines to transmit the uplink transmission on an RB set in the uplink BWP having the same RB set index as that of the RB set in which the DCI is transmitted, the UE can transmit the uplink transmission on such RB set in the uplink BWP.

After determining the at least one RB set for uplink transmission, UE 410 may perform a channel access procedure (e.g., LBT test) on each of the at least one RB set for transmitting the uplink transmission. In response to the channel access procedure for each of the at least one RB set is successful, UE 410 may, in operation 433, transmit the uplink transmission on the at least one RB set.

It should be appreciated by persons skilled in the art that the sequence of the operations in exemplary procedure 400 may be changed and some of the operations in exemplary procedure 400 may be eliminated or modified, without departing from the spirit and scope of the disclosure.

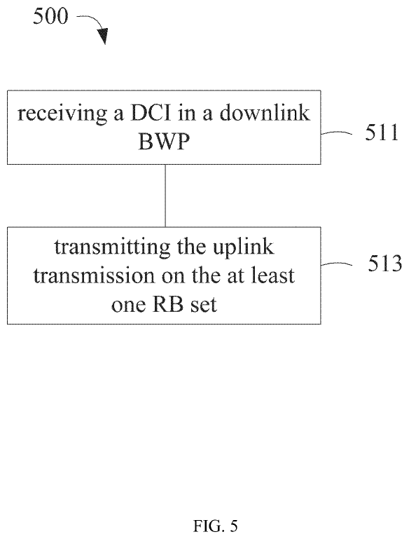

FIG. 5 illustrates a flow chart of an exemplary procedure 500 of wireless communication according to some embodiments of the present disclosure. Details described in all of the foregoing embodiments of the present disclosure are applicable for the embodiments shown in FIG. 5. The procedure may be performed by a UE, for example, UE 101a or UE 101b in FIG. 1, or UE 410 in FIG. 4.

Referring to FIG. 5, in operation 511, a UE may receive a DCI in a downlink BWP. The DCI may schedule an uplink transmission (e.g., PUSCH) in an uplink BWP. The uplink BWP may be configured in a manner similar to the one shown in FIG. 3. For example, the uplink BWP may include a plurality of RB sets, each of which may include a plurality of contiguous RBs in the uplink BWP. A guard band (e.g., intra-carrier guard band) may be configured between two adjacent RB sets of the plurality of RB sets.

After receiving the DCI, the UE may determine at least one RB set of the plurality of RB sets in the uplink BWP for transmitting the uplink transmission. The UE may determine the at least one RB set according to one of the methods described above with respect to FIGS. 1-4. The UE may perform a channel access procedure (e.g., LBT test) on each of the at least one RB set. In response to the channel access procedure for each of the at least one RB set is successful, the UE may, in operation 513, transmit the uplink transmission on the at least one RB set.

It should be appreciated by persons skilled in the art that the sequence of the operations in exemplary procedure 500 may be changed and some of the operations in exemplary procedure 500 may be eliminated or modified, without departing from the spirit and scope of the disclosure.

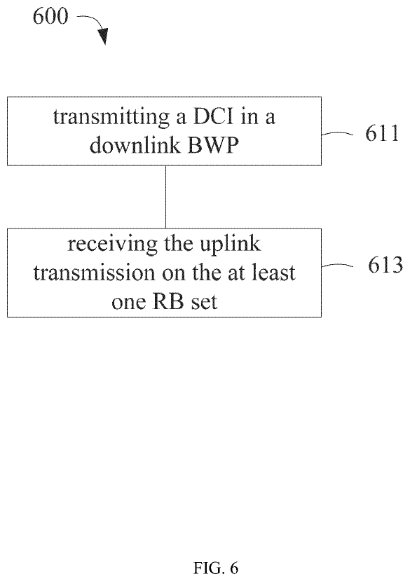

FIG. 6 illustrates a flow chart of an exemplary procedure 600 of wireless communication according to some embodiments of the present disclosure. Details described in all of the foregoing embodiments of the present disclosure are applicable for the embodiments shown in FIG. 6. The procedure may be performed by a BS, for example, BS 102 in FIG. 1 or BS 420 in FIG. 4.

Referring to FIG. 6, in operation 611, a BS may transmit a DCI in a downlink BWP. The DCI may schedule an uplink transmission (e.g., PUSCH) in an uplink BWP. The uplink BWP may be configured in a manner similar to the one shown in FIG. 3. For example, the uplink BWP may include a plurality of RB sets, each of which may include a plurality of contiguous RBs in the uplink BWP. A guard band (e.g., intra-carrier guard band) may be configured between two adjacent RB sets of the plurality of RB sets.

In operation 613, the BS may receive the uplink transmission on at least one RB set of the plurality of RB sets. The at least one RB set may be determined according to one of the methods described above with respect to FIGS. 1-4.

It should be appreciated by persons skilled in the art that the sequence of the operations in exemplary procedure 600 may be changed and some of the operations in exemplary procedure 600 may be eliminated or modified, without departing from the spirit and scope of the disclosure.

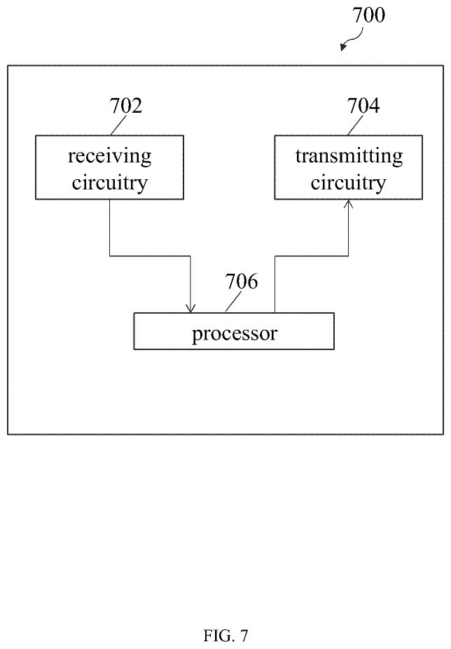

FIG. 7 illustrates an example block diagram of an apparatus 700 according to some embodiments of the present disclosure.

As shown in FIG. 7, the apparatus 700 may include at least one non-transitory computer-readable medium (not illustrated in FIG. 7), a receiving circuitry 702, a transmitting circuitry 704, and a processor 706 coupled to the non-transitory computer-readable medium (not illustrated in FIG. 7), the receiving circuitry 702 and the transmitting circuitry 704. The apparatus 700 may be a BS or a UE.

Although in this figure, elements such as processor 706, transmitting circuitry 704, and receiving circuitry 702 are described in the singular, the plural is contemplated unless limitation to the singular is explicitly stated. In some embodiments of the present disclosure, the receiving circuitry 702 and the transmitting circuitry 704 are combined into a single device, such as a transceiver. In certain embodiments of the present disclosure, the apparatus 700 may further include an input device, a memory, and/or other components.

In some embodiments of the present disclosure, the non-transitory computer-readable medium may have stored thereon computer-executable instructions to cause a processor to implement the operations with respect to the UE as described above. For example, the computer-executable instructions, when executed, cause the processor 706 interacting with receiving circuitry 702 and transmitting circuitry 704, so as to perform the steps with respect to the UE depicted in FIGS. 4 and 5. For example, the receiving circuitry 702 may receive a DCI in a downlink BWP. The DCI may schedule an uplink transmission (e.g., PUSCH) in an uplink BWP. The processor 706 may determine at least one RB set in the uplink BWP for transmitting the uplink transmission. The transmitting circuitry 704 may transmit the uplink transmission on the at least one RB set.

In some embodiments of the present disclosure, the non-transitory computer-readable medium may have stored thereon computer-executable instructions to cause a processor to implement the method with respect to the BS as described above. For example, the computer-executable instructions, when executed, cause the processor 706 interacting with receiving circuitry 702 and transmitting circuitry 704, so as to perform the steps with respect to the BS depicted in FIGS. 4 and 6. For example, the transmitting circuitry 704 may transmit a DCI in a downlink BWP. The DCI may schedule an uplink transmission (e.g., PUSCH) in an uplink BWP. The receiving circuitry 702 may receive the uplink transmission on at least one RB set in the uplink BWP.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

1. A method, comprising:
receiving a downlink control information (DCI) in a downlink bandwidth part (BWP), the DCI scheduling an uplink transmission in an uplink BWP; and
transmitting, based on the DCI, the uplink transmission on at least one resource block (RB) set of a plurality of RB sets in response to a channel access procedure is successful for the at least one RB set, each of the plurality of RB sets including a plurality of contiguous RBs in the uplink BWP, and a guard band is configured between two adjacent RB sets of the plurality of RB sets.

2. The method of claim 1, wherein the DCI is DCI format 0_0.

3. The method of claim 1, wherein a number of RB sets in the plurality of RB sets is a greatest integer less than or equal to a result of dividing a bandwidth of the uplink BWP by a bandwidth of a subband.

4. The method of claim 1, wherein the DCI includes a frequency hopping flag having at least one bit, and the frequency hopping flag indicates at least one of the at least one RB set for the uplink transmission, one of two predefined RB sets in the plurality of RB sets, or a number of RB sets from the two predefined RB sets in the plurality of RB sets.

5-10. (canceled)

11. The method of claim 1, wherein the DCI is received in an RB set in the downlink BWP having a first RB set index, and the at least one RB set has a second RB set index equal to the first RB set index.

12. The method of claim 1, wherein the DCI is received in an RB set in the downlink BWP having a first central frequency point, and the at least one RB has a second central frequency point equal to the first central frequency point.

13. The method of claim 1, wherein the at least one RB set of the plurality of RB sets has at least one of a lowest RB set index or a lowest central frequency point, or a highest RB set index or a highest central frequency point.

14-32. (canceled)

33. An apparatus, comprising:
a receiving circuitry;
a transmitting circuitry; and
a processor coupled to the receiving circuitry and the transmitting circuitry configured to cause the apparatus to:
receive a downlink control information (DCI) in a downlink bandwidth part (BWP), the DCI scheduling an uplink transmission in an uplink BWP; and
transmit, based on the DCI, the uplink transmission on at least one resource block (RB) set of a plurality of RB sets in response to a channel access procedure is successful for the at least one RB set, each of the plurality of RB sets including a plurality of contiguous RBs in the uplink BWP, and a guard band is configured between two adjacent RB sets of the plurality of RB sets.

34. An apparatus, comprising:
a receiving circuitry;
a transmitting circuitry; and
a processor coupled to the receiving circuitry and the transmitting circuitry configured to cause the apparatus to:
transmit a downlink control information (DCI) in a downlink bandwidth part (BWP), the DCI scheduling an uplink transmission in an uplink BWP; and
receive, based on the DCI, the uplink transmission on at least one resource block (RB) set of a plurality of RB sets, each of the plurality of RB sets including a plurality of contiguous RBs in the uplink BWP, and a guard band is configured between two adjacent RB sets of the plurality of RB sets.

35. The apparatus of claim 34, wherein the number of RB sets in the plurality of RB sets is a greatest integer less than or equal to a result of dividing a bandwidth of the uplink BWP by a bandwidth of a subband.

36. The apparatus of claim 34, wherein the DCI includes a frequency hopping flag having at least one bit, and the frequency hopping flag indicates the at least one RB set for the uplink transmission.

37. The apparatus of claim 36, wherein the frequency hopping flag indicates one of two predefined RB sets in the plurality of RB sets.

38. The apparatus of claim 36, wherein the frequency hopping flag indicates the number of RB sets from two predefined RB sets in the plurality of RB sets.

39. The apparatus of claim 36, wherein the frequency hopping flag indicates that the at least one RB set includes RB sets of the plurality of RB sets having odd RB set indices or even RB set indices.

40. The apparatus of claim 33, wherein the DCI is DCI format 0_0.

41. The apparatus of claim 33, wherein a number of RB sets in the plurality of RB sets is a greatest integer less than or equal to a result of dividing a bandwidth of the uplink BWP by a bandwidth of a subband.

42. The apparatus of claim 33, wherein the DCI includes a frequency hopping flag having at least one bit, and the frequency hopping flag indicates at least one of the at least one RB set for the uplink transmission, one of two predefined RB sets in the plurality of RB sets, or a number of RB sets from the two predefined RB sets in the plurality of RB sets.

43. The apparatus of claim 33, wherein the DCI is received in an RB set in the downlink BWP having a first RB set index, and the at least one RB set has a second RB set index equal to the first RB set index.

44. The apparatus of claim 33, wherein the DCI is received in an RB set in the downlink BWP having a first central frequency point, and the at least one RB set has a second central frequency point equal to the first central frequency point.

45. The apparatus of claim 33, wherein the at least one RB set of the plurality of RB sets has at least one of a lowest RB set index or a lowest central frequency point, or a highest RB set index or a highest central frequency point.
